(19) United States
(12) Patent Application Publication
(10) Pub. No.: US 2014/0036527 A1
(43) Pub. Date: Feb. 6, 2014

(54) LIGHT DISTRIBUTION SYSTEM COMPRISING SPECTRAL CONVERSION MEANS

(71) Applicants: Paul Michael Petersen, Hillerod (DK); Anders Bjarklev, Roskilde (DK)

(72) Inventors: Paul Michael Petersen, Hillerod (DK); Anders Bjarklev, Roskilde (DK)

(73) Assignee: DANMARKS TEKNISKE UNIVERSITET-DTU, Kongens Lyngby (DK)

(21) Appl. No.: 14/009,242

(22) PCT Filed: Apr. 3, 2012
(86) PCT No.: PCT/DK2012/050106

§ 371 Date: Oct. 1, 2013

Related U.S. Application Data
(60) Provisional application No. 61/471,512, filed on Apr. 4, 2011.

(30) Foreign Application Priority Data
Apr. 4, 2011 (EP) 11161001.0

(51) Int. Cl. F21V 8/00

(52) U.S. Cl. CPC G02B 6/0005
USPC 362/551

(57) ABSTRACT

A system for the distribution of white light is configured for guiding light with a multitude of visible wavelengths in a propagation direction from the supply side to the distribution side. The system includes a transport fibre and a spectral conversion fibre. The transport fibre has a length extending from a first end to a second end, and a spectral transmission characteristics. The transport fibre is operationally connected to the spectral conversion fibre having a length extending from an input end to an output end. The spectral conversion fibre includes a photoluminescent agent for converting light of a first wavelength to light of a second, longer wavelength. A spectral conversion characteristics of the spectral conversion fibre is essentially determined by the spectral absorption and emission properties of the photoluminescent agent, the amount of photoluminescent agent, and the distribution of the photoluminescent agent in the spectral conversion fibre.

### TECHNICAL FIELD

The present invention relates to the field of daylighting, and in particular to a light distribution system for distributing white light, having a supply side and a delivery side, the light distribution system being configured for guiding light with a multitude of visible wavelengths in a propagation direction from the supply side to the distribution side, the light distribution system comprising a transport fibre having a length extending from a first end to a second end, and a spectral transmission characteristics.

According to further aspects of the invention, a method for distributing white light, and a method of providing a light distribution system for the distribution of white light are disclosed.

### BACKGROUND

Daylighting systems collect available daylight by means of collectors arranged at the outside of a building or similar structure, and transfer/distribute the collected light to a point of use inside of the building/structure, typically by means of one or more optical fibres. Daylighting systems have two major advantages over purely artificial lighting. Firstly energy consumption for illumination of internal spaces by artificial lighting is reduced, and secondly illumination using daylight is perceived as a more pleasant and thus less stressful to users subject to the illumination. This is important to the wellbeing of the users, in particular if exposed over long periods of time. In fact in certain legislations, work place regulations even require daylight illumination.

White light may be provided from different sources, such as daylight or artificial sources emitting light comprising a multitude of wavelengths. Light may be characterised by its colour rendering properties, i.e. the effect of the light on the colour appearance of objects. The human eye interprets colours based on the colour spectrum of the light source. A light source that does not emit light at a specific wavelength band cannot render the colours in this band for human vision. The ability of an illumination source to render colour is described by colour rendering models. In a commonly used model colour rendering is represented by a colour rendering index CRI, which is calculated as the arithmetic mean of specific colour rendering indices for each member of a set of test colours, in accordance with the CIE 13.3-1995 publication “Method of Measuring and Specifying Colour Rendering Properties of Light Sources”. The CRI value ranges up to 100. Daylight being a reference illumination source of the colour rendering model has by definition a colour rendering index CRI of 100. Light sources with a high value for CRI are important for many applications. Preferably for applications within high quality lighting, CRI should be higher than 90.

Distributing the collected light by means of optical fibres has the advantage that the light source/daylight collector can be placed remote and essentially independent of the location of the point of use. However, such installations may require considerable lengths of optical fibres. At the same time, the spectral transmission characteristics of common optical fibres exhibits pronounced absorption peaks in certain bands of the visible spectrum. The light delivered through such a transport fibre is therefore spectrally distorted to a degree that the delivered light is perceived as unnatural and thus not suited for lighting applications.

FIG. 1 shows an output spectrum from a prior art daylighting system (Parans) comprising a daylight collector feeding collected daylight to a transport optical fibre, which transmits and eventually outputs the light at a delivery end. The corresponding colour rendering index CRI of the output spectrum is calculated to 70. Since the input light is daylight, the colour rendering index has been reduced from 100 to 70—mainly due to spectral distortion resulting from the spectral transmission characteristics of the transport fibre.

While specialty fibres with a more favourable spectral transmission characteristics may be conceived as replacement for the transport fibres, the cost of such specialty fibres at the required lengths will in most cases be considered inhibitive for an economically viable use in real world applications.

U.S. Pat. No. 5,579,429 discloses a fluorescent light transmitting optical fibre made from a PMMA based plastic material. The fluorescent optical fibre disclosed in U.S. Pat. No. 5,579,429 may be pumped by an external light source and may be used for illumination applications.

### DISCLOSURE OF THE INVENTION

One object of the present invention is therefore providing a system and method for the distribution of white light overcoming the above-mentioned disadvantages and/or providing an alternative.

According to one aspect of the invention the object may be achieved by a light distribution system for the distribution of white light, the light distribution system having a supply side and a delivery side, the light distribution system being configured for guiding light with a multitude of visible wavelengths in a propagation direction from the supply side to the distribution side, the light distribution system comprising a transport fibre and a spectral conversion fibre, the transport fibre having a length extending from a first end to a second end, and a spectral transmission characteristics, the transport fibre being operationally connected to the spectral conversion fibre having a length extending from an input end to an output end, the spectral conversion fibre comprising a photoluminescent agent for converting light of a first wavelength to light of a second, longer wavelength, a spectral conversion characteristics of the spectral conversion fibre being essentially determined by the spectral absorption and emission properties of the photoluminescent agent, the amount of photoluminescent agent, and the distribution of the photoluminescent agent in the spectral conversion fibre, wherein the first and second wavelengths are selected according to the spectral transmission characteristics of the transport fibre such that transmission loss in the transport fibre at the first wavelength is less than at the second wavelength.

Typically in practice, the transport fibre is a relatively cheap off-the shelf multimode optical fibre for long-distance transport of light in a broad spectral range. Since the system is intended for distributing white light, the transport fibre should be configured for simultaneously guiding light with a multitude of different wave lengths throughout the whole visible range of the electromagnetic spectrum, i.e. wave lengths of about 400 nm to about 800 nm. White light may be defined as a mixture/superposition of light with a multitude of different wavelengths and with a spectral distribution characterised by the perceptive value of the light, e.g. according to a colorimetric model, such as the above-mentioned colour-rendering index CRI. White light may thus be defined as light having a minimum CRI-value of 90.

The transport fibre and the spectral conversion fibre are operationally connected/coupled so as to be able to couple guided light from one fibre to guided light in the other fibre.

The spectral conversion fibre comprises a photoluminescent agent, i.e. a material or a combination of materials that may be excited by absorption of incident light, and which relaxes from the excited states by emitting at least part of the absorbed energy through radiative transitions. The photoluminescent agent may be a mixture of a plurality of different substances emitting light upon optical excitation. The photoluminescent effect may be brought about e.g. by fluorescence, by phosphorescence, or by light emission from quantum dots, wherein a redshift is observed between the absorbed photons and the emitted photons (neglecting higher order non-linear absorption processes involving multiple photons). Note that a wavelength shift is required in order to bring about a spectral conversion effect. The absorption and emission properties of the photoluminescent agent thus determine the spectral redistribution of the light. Preferably, the excitation of the photoluminescence may be achieved by broadband absorption above a given photon energy. Preferably for each substance, the emission occurs within a welldefined band associated with a given radiative recombination transition. Preferably, the photoluminescence agents comprise materials of high quantum efficiency for radiative recombination upon optical excitation. For example, in certain embodiments, the spectral conversion fibre is doped with a phosphorescent material or a quantum dot material or both.

The total amount of photoluminescent agent having an overlap with the mode fields propagating in the spectral conversion fibre determines the conversion intensity. The overlap with a given mode (or set of modes) is determined by the spatial distribution of the photoluminescent agent in the optical fibre. The spatial distribution may be decomposed in a transverse distribution referring to the distribution of photoluminescent agent as seen in a cross-sectional plane perpendicular to the axial direction of the optical fibre, and a longitudinal distribution parallel to the axial direction.

Providing the photoluminescent agent in a spectral conversion fibre has the advantage that it can easily be integrated with a transport fibre. Furthermore, the spatial distribution may be controlled with high precision, at a great degree of flexibility, and compatible with the guided propagation of the light to be distributed. Thereby a high precision and flexibility is achieved for controlling the spectral conversion interaction between the guided light and the photoluminescent agent. In addition, distributing the photoluminescent agent along the propagation path of the light enhances the efficiency of the spectral conversion effect. These advantages are significant for the production and installation, as well as for the performance of the light distribution system in terms of the quality of the delivered light.

The spectral conversion from a first wavelength to a second, longer wavelength, wherein transmission loss in the transport fibre at the first wavelength is less than at the second wavelength has the effect of redistributing the spectral power densities from spectral regions that are less affected by transmission loss in the transport fibre to spectral regions that are more affected. Thereby the problem of spectral distortion by the transport fibre is at least mitigated.

Further according to one embodiment of the invention, at least the second wavelength is selected according to a colour rendering model describing colour rendering by reference to a set of standard test colours, wherein the second wave length is selected from a wavelength band corresponding to one of the test colours of the colour rendering model.

By selecting the emission of the photoluminescent agent to occur at a wave length of excessive absorption/loss in the transport fibre which at the same time is chosen to fall within a wavelength band corresponding to one of the standardized test colours of the colour rendering model, the colour rendering of the output light is improved as compared to output light from a system without a spectral conversion fibre.

The spectral conversion characteristics of the spectral conversion fibre is thus configured to compensate for deviation from a pre-determined desired spectral distribution of the light emitted on the delivery side of the light distribution system. Preferably, the desired spectral distribution is defined by the colour rendering ability according to a colour rendering model, for example by specifying the above-mentioned colour rendering index CRI calculated according to CIE 13.3-1995, “Method of Measuring and Specifying Colour Rendering Properties of Light Sources”.

As mentioned above, in certain embodiments, the spectral conversion fibre is doped with a phosphorescent material or a quantum dot material. In the case of a phosphorescent material the material is excited by the blue or UV light present in the fibre and red or yellow light is re-emitted. Referring to the output spectrum of the prior art system shown in FIG. 1, red light around 620 nm is missing. In this case the colour rendering can be improved by adding a phosphorescent material that emits light in the red part of the visible spectrum. The phosphorescent materials could for example be Magnesium fluorogermanate doped with manganese or YAG:Ce. Another possibility is to use quantum dots. The quantum dots are made of semiconductor material and they work similar as the phosphorescent materials, but they allow a more detailed control of the emitting wavelength. This property leads in many cases to a much better colour rendering. The emitting wavelength from the quantum dots can be controlled completely to emit light everywhere in the visible region by selecting a proper size of the dot and the type of the semiconductor material. Using a combination of several quantum dots is possible to obtain different colour temperatures.

Further according to one embodiment of the invention, the photoluminescent agent is essentially evenly distributed in a longitudinal direction over an active length of the spectral conversion fibre.

The active length is the length of the spectral conversion fibre that is doped with a photoluminescent agent. Typically, the photoluminescent agent is distributed whole length of the spectral conversion fibre, and the active length is equal to the length of the spectral fibre.

An even distribution of the photoluminescent agent in the longitudinal direction means that the concentration has translational symmetry in directions along the principal axis of the fibre, i.e. the concentration of the photoluminescent agent is essentially constant in directions along the spectral conversion fibre.

A spectral conversion fibre may thus be pre-configured to exhibit a length-specific spectral conversion characteristics fibre, wherein the pre-configuration comprises defining the lateral distribution pattern that affects the spatial overlap between the guided light and the photoluminescent agent and/or the spectral absorption and emission characteristics. The spectral conversion may then be adapted to a particular level of compensation by merely adapting the length of the spectral conversion fibre. The translational symmetry of the longitudinal distribution of the photoluminescent agent thus allows providing a spectral conversion fibre for a particular light distribution system in two separate steps, namely mass producing a pre-configured spectral fibre and subsequently adapting the spectral conversion fibre to a particular use.

Further according to one embodiment of the invention, the photoluminescent agent is a mixture of a plurality of photoluminescent substances with different spectral absorption and emission characteristics.

Providing a mixture of different photoluminescent substances dispersed in the spectral conversion fibre allows superimposing the spectral conversion characteristics of the individual substances so as to tailor a desired spectral conversion characteristics with regard to the spectral absorption and emission properties.

The mixture may be configured to provide a spectral conversion that erodes or obviates spectral finger prints stemming from the transport fibre. To that end, the spectral conversion characteristics of the conversion fibre should essentially match the spectral transmission characteristics of the transport fibre, wherein radiative emission is provided throughout spectral regions/bands of pronounced transmission loss, and wherein said emission is powered by absorption of light in spectral regions/bands where transmission loss is less pronounced. As mentioned above, substances well-suited for providing such mixtures are semiconductor nanoparticles, also referred to as quantum dot materials.

Further according to one embodiment of the invention, the spectral conversion fibre is a hollow fibre, the photoluminescent agent being filled into axial channels of the hollow fibre.

Hollow fibres may be provided in a large variety of lateral patterns with translational symmetry in the longitudinal direction. Furthermore the hollow channels facilitate introducing materials after fabrication of the fibre. This is advantageous when the photoluminescent agent comprises substances that are not compatible with high processing temperatures that may occur during the production of optical fibres. Filling may be performed by introducing the photoluminescent agent in solution/dispersed in a liquid matrix, and subsequently curing the matrix to fix the distribution.

Further according to one embodiment of the invention, the spectral conversion fibre is an optical fibre with a solid core region, the fluorescent agent being dispersed in the solid core region. Thereby a large overlap of the spatial distribution with the intensity distribution of the guided light is achieved.

Further according to one embodiment of the invention, the distribution system comprises one or more spectral conversion fibres, the one or more spectral conversion fibres being arranged at the delivery end, i.e. after a transport fibre as seen in the propagation direction, and/or at the supply end, i.e. before the transport fibre as seen in the propagation direction, and/or in between portions of the transport fibre.

Spectral conversion compensating for transmission loss in a transport fibre may be performed prior, in between and/or after transmission through the transport fibre, depending on the requirements of a particular application or configuration of a particular system. For example, in a system delivering light supplied from a central lighting source, e.g. a roof collector, to a plurality of points of use, spectral conversion at the supply end has the advantage that spectral compensation is performed centrally, whereas spectral compensation at the delivery end has the advantage that the spectral distribution of the delivered light may be adapted individually to the specific requirements of a particular point of use. Individual compensation has the advantage that different lengths of the transport fibres for different points of use can be accounted for. Also different lighting tasks requiring different spectral compositions of the illumination may be supported. Spectral compensation may also be performed in between portions of transport fibre, for example in order handle a plurality of points of use in groups. Similarly, light supplied from different sources and combined to be distributed using a common light distribution system may be handled centrally, individually and/or in groups.

Further according to one embodiment of the invention, a fibre illumination system comprises a light distribution system according to any of the above-mentioned embodiments, and at least one daylight collector connected to the supply side of the light distribution system and/or an artificial light source.

The fibre illumination system may be applied for delivering daylight to internal spaces, wherein daylight is collected by one or more daylight collectors at the outside of a building and distributed to points of use inside the building. The term building as used here refers broadly to buildings and similar structures, such as office buildings, housing, underground spaces, shelters, marine and submarine structures, ships/vessels, or the like.

The system may further comprise an artificial light source for supplementing the daylight illumination, for example in periods where daylight is not available. Furthermore, the artificial light may be used to complement the spectral distribution in order to achieve a desired light output at the delivery end, wherein the artificial light may contribute directly or via a spectral conversion to the output spectral distribution. Advantageously, the desired output is specified by perceptive values according to colorimetric considerations as mentioned above. Preferably, the colorimetric considerations include a colour rendering index calculated according to a predetermined colour rendering model. The artificial light source may be provided at the supply side, delivery side or coupled into the light distribution system at an intermediate position.

Further according to one embodiment of the invention, the artificial light source is provided at the delivery side. This configuration has the advantage that transmission and/or conversion losses are avoided and the light energy generated by the artificial light source is used more efficiently at the point of use.

Further according to one embodiment of the invention, the artificial light source is a light emitting diode source.

Light emitting diode (LED) sources are energy saving. This is of particular importance when the available daylight intensity is insufficient or absent, i.e. when the LED sources have to take over the illumination task.

LED sources have the further advantage that a source comprising a combination of different emission wavelengths may provide light similar to white light which may be tuned in terms of the spectral composition. For example, LED sources that use combinations of coloured LEDs may be used simultaneously with daylight supplied from the daylight collector. The light from the LED-source may thus be used to compensate the combined light output at a given point to achieve a desired/optimised colour rendering and/or colour temperature.

Further according to one embodiment of the invention, a fibre illumination system further comprises a spectral conversion fibre configured so as to compensate for spectral distortion of the light supplied by the daylight collector.

In certain cases, the light output from a daylight collector exhibits spectral distortion, i.e. spectrally uneven loss resulting in a deterioration of the colour rendering properties of the conveyed light. Analogue to compensating/correcting the output light from the light distribution system, a spectral conversion fibre may also be used for compensating/correcting the output light from the daylight collector. Thereby, the total output light delivered by the fibre illumination system to a point of use may be compensated/corrected.

According to a further aspect, a method of providing a spectrally compensated light distribution system comprises the steps of
providing a transport fibre of a given length and having a given spectral transmission characteristics,
pre-configuring a spectral conversion fibre to have a length-specific spectral conversion characteristics, wherein the spectral conversion fibre comprises a photoluminescent agent for converting light of a first wavelength to light of a second, longer wavelength, wherein the pre-configured length-specific spectral conversion characteristics is determined by the spectral absorption and emission properties, the concentration, and a transverse distribution of the photoluminescent agent in the spectral conversion fibre, wherein the first and second wavelengths are selected according to the spectral transmission characteristics of the transport fibre such that transmission loss in the transport fibre at the first wavelength is less than at the second wavelength,
selecting the length of the spectral conversion fibre according to the length of the transport fibre, and
operationally coupling the spectral conversion fibre to the transport fibre.

Separating the process of providing a spectral conversion fibre into a pre-configuration step and a length selection step facilitates low-cost manufacturing and simple installation. In particular the separation of these two steps allows manufacturing the components of such a fibre optical light distribution system, and in particular of the pre-configured spectral conversion fibre to stock using cost reducing mass production, whereas delaying the final configuration for a particular installation is delayed to a later point in time and reduced to merely adjusting the length so as to obtain a desired light output. The spectral conversion fibre may be pre-configured to correspond to a particular type of transport fibre.

A kit of parts may comprise a given transport fibre with a given transmission characteristics and a corresponding spectral conversion fibre that is pre-configured according to the transmission characteristics of the transport fibre. The transport fibre and the spectral conversion fibre may be reeled separately at arbitrary lengths and brought to an installation site where the transmission fibre is installed together with other infrastructure installations, such as electrical or data network installations. Once installed the spectral properties of the output at a point of use may be tuned by merely selecting/adjusting the length of the spectral conversion fibre. The output may be calibrated against a reference light source representing a desired light output, e.g. by using a colour rendering model for measuring the colour rendering properties of the output.

Furthermore, the same advantages relating to the details of the light distribution systems apply as discussed above.

According to a yet a further aspect, a method is provided for correcting the spectral transmission characteristics of a light distribution system comprising a transport fibre with a given transmission characteristics. The method comprises the steps of
operatively coupling a spectral conversion fibre to the transport fibre, so as to pass light propagating through the distribution system through the spectral conversion fibre,
absorbing first spectral components of the light by a photoluminescent agent present in the spectral conversion fibre, and
radiatively emitting at least some of the energy absorbed by the photoluminescence agent as second spectral components having a lower photon energy than the first spectral components, wherein the first and second spectral components are selected according to the transmission characteristics of the transport fibre such that transmission loss experienced by the first spectral components is less than transmission loss experienced by the second spectral components.

Thereby a spectral distortion introduced by the transmission loss in the transport fibre may be mitigated by redistributing light from spectral regions that are less affected by transmission loss in the transport fibre to spectral regions that are more affected, as discussed above with reference to the light distribution system and the fibre illumination system. Further advantages of particular features, such as using an optical fibre as a spectral converter are also discussed above.

Further according to one embodiment of a method for correcting the spectral transmission characteristics of a light distribution system, the second spectral components are selected according to a model describing colour rendering by reference to a set of test colours, wherein the second spectral components fall within one or more of the spectral bands representing the test colours.

The correction of the spectral transmission characteristics is based on redistributing light from spectral regions that are less affected by transmission loss in the transport fibre to spectral regions that are more affected using photoluminescence implying a redshift of the emitted radiation with respect to the absorbed radiation. Selecting to redistribute the light to a spectral band corresponding to a test colour allows to actively improve the colour rendering ability of the output light. Preferably, the colour rendering ability is specified according to a colour rendering model, for example by specifying the above-mentioned colour rendering index CRI calculated according to CIE 13.3-1995, “Method of Measuring and Specifying Colour Rendering Properties of Light Sources”.

In certain cases, already the input light supplied to a supply end of the light distribution system exhibits a non-ideal colour rendering ability as described e.g. by a colour rendering index CRI less than 100. By appropriate configuration of the spectral conversion characteristics of the spectral conversion fibre, the spectral composition of the input light may be redistributed in such a manner that the colour rendering ability of the output light is increased with respect to the input light.

Furthermore, the light distribution system comprising a spectral conversion fibre may be combined with artificial light, preferably provided from LED-sources coupled into the propagation path of the light distribution system at the supply end, the delivery end or at appropriate coupling points in between the supply and delivery ends.

### BRIEF DESCRIPTION OF THE DRAWINGS

In the following the invention will be further described with reference to particular embodiments. The drawings show on

FIG. 1 an output spectrum of a prior art daylight illumination system,

FIG. 2 schematically, a light distribution system according to one embodiment,

FIG. 3 schematically, a light distribution system according to another embodiment,

FIG. 4 schematically, a fibre illumination system according to one embodiment,

FIG. 5 schematically, an oblique sectional view of a spectral conversion fibre comprising a photoluminescent agent,

FIG. 6 schematically, a transverse sectional view of the spectral conversion fibre of FIG. 7 along line VI-VI, and

FIG. 7 schematically, a longitudinal sectional view of the spectral conversion fibre of FIG. 6 along line VII-VII.

### DETAILED DESCRIPTION OF THE INVENTION

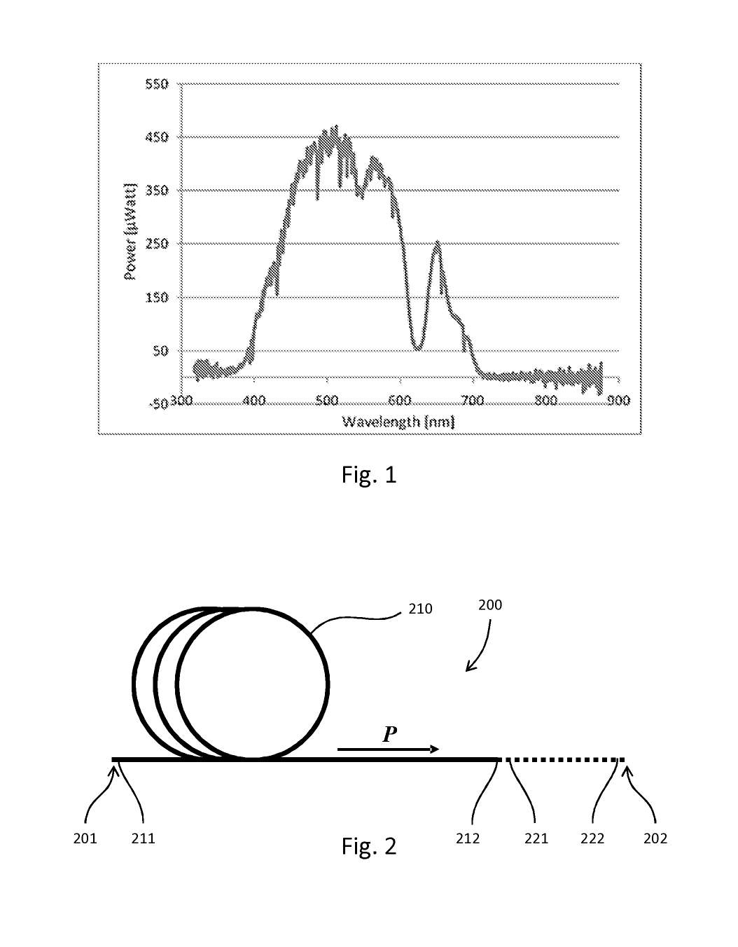

FIG. 2 shows a light distribution system 200 according to one embodiment of the invention. Light supplied to the system 200 at a supply side 201 is guided in a propagation direction P from the supply side to a delivery side 202. The light distribution system 200 comprises a transport fibre 210 extending from a first end 211 to a second end 212. At the second end 212, the transport fibre 210 is operationally connected to the input end 221 of a spectral conversion fibre 220 extending from the input end 221 to an output end 222. The transport fibre 210 has a spectral transmission characteristics exhibiting spectral loss features, i.e. spectral regions where transmission loss is higher as compared to other spectral regions. The loops of the transport fibre 210 indicate that in practical applications, the transport fibre 210 has a considerable length ranging form several tens of metres for small systems to several kilometres or more for large building installations. The spectral features in the spectral transmission characteristics of the transport fibre 210 therefore may result in a considerable spectral distortion as perceived by a coloured output from white input light. This spectral distortion may be measured in terms of the colour rendering index CRI. In case of the prior art system of FIG. 1, a decrease in colour rendering index from CRI(in)=100 for the input light (direct sunlight) to CRI(out)=70 for the output light is observed for a transport fibre length of only 20 m. The spectral distortion may be corrected by coupling the light emerging from the second end 212 of the transport fibre 210 into the input end 221 of the spectral conversion fibre 220. On passing through the spectral conversion fibre 220 the light interacts with a photoluminescent agent present in the spectral conversion fibre 220 so as to redistribute light from spectral regions with relatively lower transmission loss in the transport fibre 210 to spectral regions of relatively higher loss in the transmission fibre 210, thereby mitigating/correcting/compensating for the spectral distortion which the light subdued in the transport fibre 210.

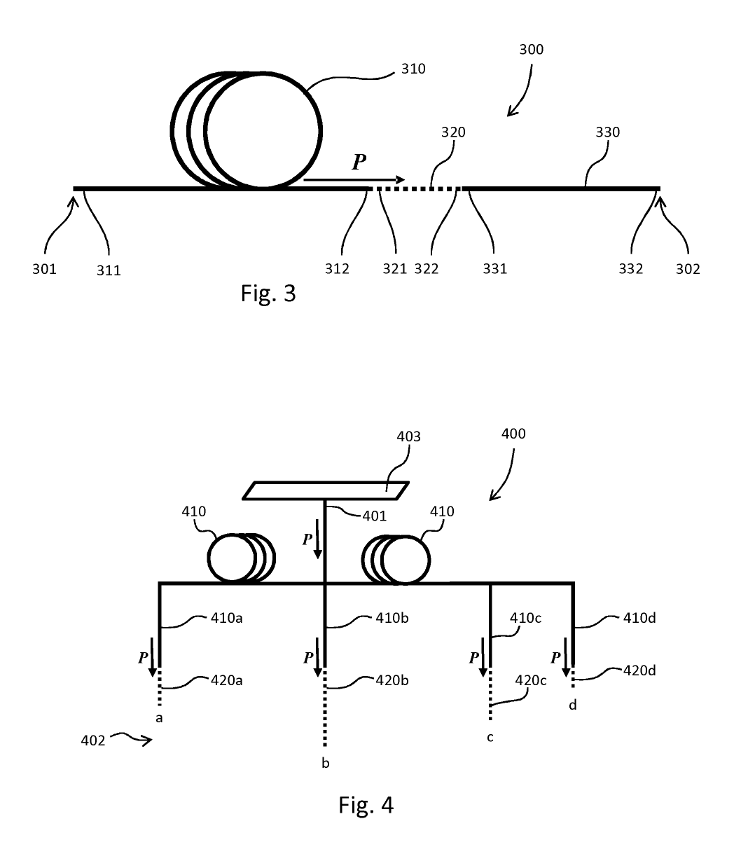

Another embodiment of a light distribution system 300 is shown in FIG. 3, wherein similar reference numbers refer to similar parts. Emphasis is therefore on the differences with respect to the light distribution system 200 of FIG. 2. The system 300 shown in FIG. 3 comprises a spectral conversion fibre 320 in an intermediate position, operationally coupled to a first transport fibre portion 310 to receive input light at the input end 321, and further operationally coupled to a second transport fibre portion 330 to transfer spectrally converted light from the output end 322 of the spectral conversion fibre 320 to the second transport fibre portion 330 at a first end 331. The output light is finally delivered at the delivery side 302 of system 300 through a second end 332 of the second transport fibre portion 330. In this embodiment, the spectral conversion characteristics of the spectral conversion fibre is preferably configured such that the spectral transmission characteristics of both transport fibre portions 310, 330 are taken into account.

FIG. 4 shows a daylight illumination system 400 comprising a daylight collector 403 coupled to the supply side 401 of a light distribution system. The light is distributed through transport fibres 410 and delivered to different points of use (a-d) through branches 410a-d, each branch being provided with a spectral conversion fibre 420a-d, each spectral conversion fibre 420a-d having a different length according to the desired/required level of compensation at each point of use (a-d).

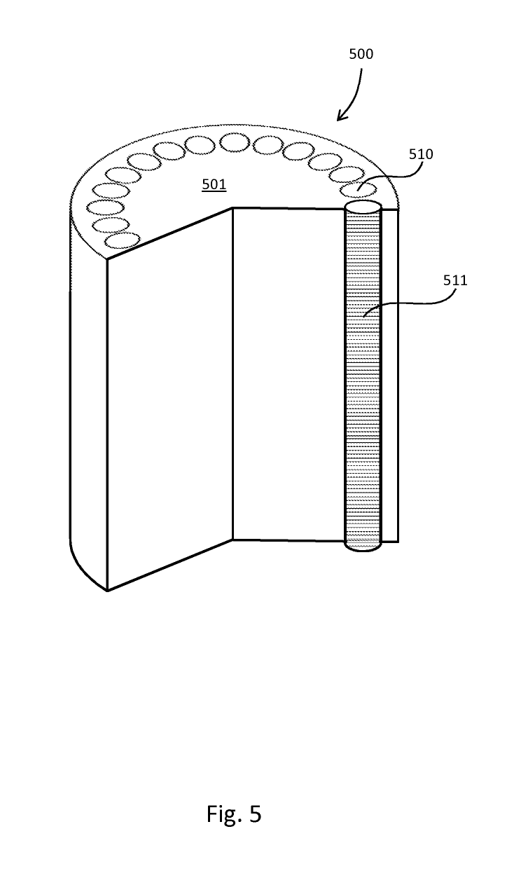

Referring to FIGS. 5-7, one embodiment of a spectral conversion fibre 500, 600, 700 is briefly described in the following. FIGS. 5-7 show different sectional views of an active portion of the spectral conversion fibre 500, 600, 700, comprising a solid core 501, 601, 701, and peripherally thereto a circular arrangement of spectral conversion elements 510, 610, 710 extending parallel to a longitudinal direction defined by the principal axis of the spectral fibre. Advantageously, the photoluminescent agent 511, 611, 711 is dispersed in a solidified matrix material, and may comprise for example a mixture of differently sized semiconductor nanoparticles. The configuration of the active region shown in FIGS. 5-7 allows for propagation of light through the core 501, 601, 701 while providing sufficient overlap for interaction of the light with the spectral conversion elements 510, 610, 710 comprising the photoluminescent agent 511, 611, 711.

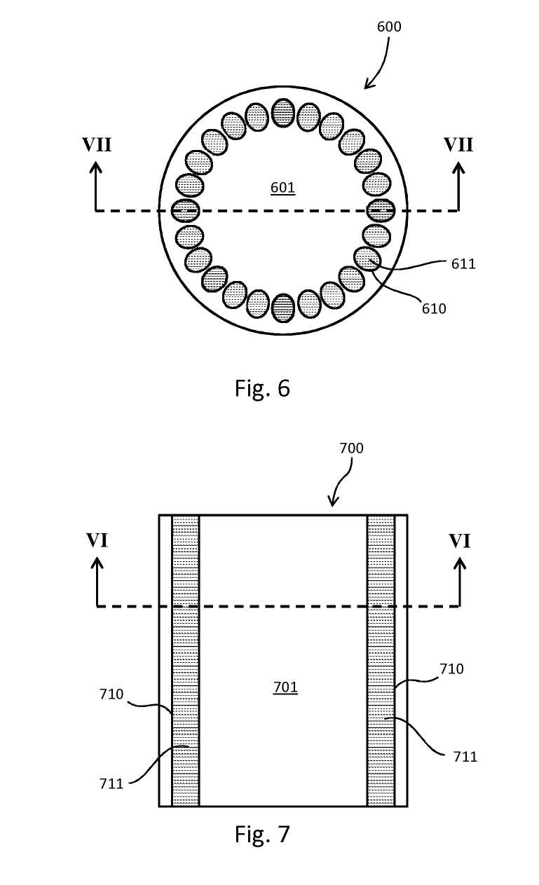

FIG. 6 shows the lateral distribution of the photoluminescent agent 611 as seen in a transverse sectional view along line VI-VI in FIG. 7. The photoluminescent agent 611 is dispersed in a matrix material in spectral conversion elements 610 having an elliptical cross-section and being arranged in a circle around the solid core 601.

FIG. 7 shows the longitudinal distribution of the photoluminescent agent 711 as seen in a longitudinal sectional view along line VII-VII in FIG. 6. The spectral conversion fibre 700 exhibits translational symmetry along the longitudinal direction. The photoluminescent agent 711 is dispersed in a matrix material in spectral conversion elements 710 arranged adjacent to a solid core 701. The cross-section of the spectral conversion elements 710 is constant in the longitudinal direction. Assuming an essentially uniform distribution of the photoluminescent agent 711 in the spectral conversion elements 710, the spectral conversion fibre 700 may be characterised by a length-specific spectral conversion characteristics. Varying the length thus merely affects the level/amount of spectral conversion, whereas the spectral variation remains constant as determined by the material choice for the photoluminescent agent 711 and the spectral variation of the overlap with the lateral distribution of the photoluminescent agent 711 as different wave lengths propagating in the same cross-sectional geometry may give rise to different modes.

### REFERENCE NUMBERS

200, 300 light distribution system
400 fibre illumination system
201, 301, 401 supply side
202, 302, 402 delivery side
403 daylight collector
210, 310, 330 transport fibre
410 transport fibre
410a-d distribution branch transport fibres for points of use a-d
211, 311, 331 first end of transport fibre
212, 312, 332 second end of transport fibre
220, 320 spectral conversion fibre
420a-d distribution branch spectral conversion fibres for points of use a-d
221, 321 input end of spectral conversion fibre
222, 322 output end of spectral conversion fibre
500, 600, 700 spectral conversion fibre
501, 601, 701 core
510, 610, 710 spectral conversion element
511, 611, 711 photoluminescent agent
P direction of light propagation
a, b, c, d points of use

1. Light distribution system (200, 300) for the distribution of white light, having a supply side (201, 301, 401) and a delivery side (202, 302, 402), the light distribution system being configured for guiding light with a multitude of visible wavelengths in a propagation direction (P) from the supply side to the delivery side, the light distribution system comprising a transport fibre (210, 310, 330, 410, 410a-d) and a spectral conversion fibre (220, 320, 420a-d, 500, 600, 700),
the transport fibre (210, 310, 330, 410, 410a-d) having a length extending from a first end (211, 311, 331) to a second end (212, 312, 332), and a spectral transmission characteristics, the transport fibre being operationally connected to
the spectral conversion fibre (220, 320, 420a-d, 500, 600, 700) having a length extending from an input end (221, 321) to an output end (222, 322), the spectral conversion fibre comprising a photoluminescent agent (511, 611, 711) for converting light of a first wavelength to light of a second, longer wavelength, a spectral conversion characteristics of the spectral conversion fibre being essentially determined by the spectral absorption and emission properties of the photoluminescent agent, the amount of photoluminescent agent, and the distribution of the photoluminescent agent in the spectral conversion fibre,
wherein the first and second wavelengths are selected according to the spectral transmission characteristics of the transport fibre such that transmission loss in the transport fibre at the first wavelength is less than at the second wavelength.

2. Light distribution system according to claim 1, wherein at least the second wavelength is selected according to a colour rendering model describing colour rendering by reference to a set of standard test colours, wherein the second wave length is selected from a wavelength band corresponding to one of the test colours of the colour rendering model.

3. Light distribution system according to claim 1, wherein the photoluminescent agent is essentially evenly distributed in a longitudinal direction over an active length of the spectral conversion fibre.

4. Light distribution system according to claim 1, wherein the photoluminescent agent is a mixture of a plurality of photoluminescent substances with different spectral absorption and emission characteristics.

5. Light distribution system according to claim 1, wherein the spectral conversion fibre is a hollow fibre, the photoluminescent agent being filled into axial channels of the hollow fibre.

6. Light distribution system according to claim 1, wherein the spectral conversion fibre is an optical fibre with a solid core region, the fluorescent agent being dispersed in the solid core region.

7. Light distribution system according to claim 1, wherein the distribution system comprises one or more spectral conversion fibres, the one or more spectral conversion fibres being arranged at the delivery end, i.e. after a transport fibre as seen in the propagation direction, and/or at the supply end, i.e. before the transport fibre as seen in the propagation direction, and/or in between portions of the transport fibre.

8. Fibre illumination (400) system comprising a light distribution system according to claim 1, and at least one daylight collector (403) connected to the supply side of the light distribution system and/or an artificial light source.

9. Fibre illumination system according to claim 8, wherein the artificial light source is provided at the delivery side.

10. Fibre illumination system according to claim 8, wherein the artificial light source is a light emitting diode source.

11. Fibre illumination system according to claim 8, further comprising a spectral conversion fibre configured so as to compensate for spectral distortion of the light supplied by the daylight collector.

12. Method of correcting the spectral transmission characteristics of a light distribution system (200, 300) comprising a transport fibre (210, 310, 330, 410, 410a-d) with a given transmission characteristics, the method comprising the steps of
operatively coupling a spectral conversion fibre (220, 320, 420a-d, 500, 600, 700) to the transport fibre, so as to pass light propagating through the distribution system through the spectral conversion fibre,
absorbing first spectral components of the light by a photoluminescent agent (511, 611, 711) present in the spectral conversion fibre, and
radiatively emitting at least some of the energy absorbed by the photoluminescence agent as second spectral components having a lower photon energy than the first spectral components, wherein the first and second spectral components are selected according to the transmission characteristics of the transport fibre such that transmission loss experienced by the first spectral components is less than transmission loss experienced by the second spectral components.

13. Method according to claim 12, wherein the second spectral components are selected according to a model describing colour rendering by reference to a set of test colours, wherein the second spectral components fall within one or more of the spectral bands representing the test colours.
